(19) United States
(12) Patent Application Publication
(10) Pub. No.: US 2022/0058601 A1
(43) Pub. Date: Feb. 24, 2022

(54) MIRRORING AUTOMATED TELLER MACHINE USER INTERFACE

(71) Applicant: Wells Fargo Bank, N.A., San Francisco, CA (US)

(72) Inventors: Raziq Yaqub, Stewartsville, NJ (US); Ramanathan Ramanathan, Bellevue, WA (US); Abhijit Rao, Irvine, CA (US)

(21) Appl. No.: 15/726,464

(22) Filed: Oct. 6, 2017

(51) Int. Cl. G06Q 20/10; G06Q 20/40; G06Q 20/32; G06Q 20/38; B25J 18/02

(52) U.S. Cl. CPC G06Q 20/1085; G06Q 20/4014; G06Q 2220/00; G06Q 20/3829; B25J 18/025; G06Q 20/3223

(57) ABSTRACT

The innovation discloses systems and methods of mirroring a User Interface (UI) of an Automatic Teller Machine (ATM) on a Display screen in a Vehicle (DIV) or mobile Device in Vehicle (DIV) of an occupant of a vehicle which stops in close proximity to the ATM for a financial transaction. The innovation can employ an App (or application) installed in the DIV, smart software installed in the ATM, and Service Support Servers (SSS) in a cloud or bank network. A Device Management Server (DMS) manages the SSS and acts as a gateway between the ATM and SSS. A multi-level (e.g., three level) authentication/authorization can be employed whereby 1) the DIV and ATM are verified and connected to a secure network, 2) the user is verified, and 3) the dispersal of funds into the cabin of the vehicle is authorized.

### BACKGROUND

Increased automation in ATM (Automated Teller Machine) banking is desirable for a number of reasons. With increased automation comes a use for more modern graphical user interfaces (GUIs) for customers and updated account security measures. This change is driven, in part, by technological advances in the market place. For example, some anticipate that the proliferation of self-driving cars will require ATMs, as a practical matter, to be robotic. In keeping with such developments, large touch-screens in vehicle dashboards are increasingly prevalent.

Today, equipment malfunctions, inclement weather, etc. can create inconveniences for customers using walk-up or drive-up ATMs. For example, workarounds or contingency plans are needed when a patron forgets a bank card at the ATM, or when a bank card is trapped in the machine due to mechanical malfunctions.

Enhanced security is needed against claw-like devices inserted into ATM slots to snatch money from inside dispenser before it is released, skimmers (gadgets mounted to the front of the normal ATM card slot that read the ATM card number and transmits it to unauthorized individuals), wireless cameras disguised to look like a leaflet holder and mounted in a position to view ATM PIN (Personal Identification Number) entries, and similar modern security threats were not completely appreciated when ATMs were created.

### BRIEF SUMMARY OF THE DESCRIPTION

Embodiments of the innovation described herein address conventional shortcomings and/or achieve other advantages. The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of mirroring or otherwise replicating (e.g., functionally) the Graphical User Interface (GUI) of an Automatic Teller Machine (ATM) onto a display screen in a vehicle or via a mobile Device in Vehicle (DIV). In aspects, the mirroring operation can employ a three level authentication/authorization to facilitate a secure financial transaction from within a vehicle. The level 1 authentication establishes connectivity to mirror the ATM user interface on DIV. The level 2 authentication authorizes the user to utilize the ATM to perform financial transactions. The level 3 authentication authorizes depositing or transfer of funds in the cabin of the vehicle.

An example system of the innovation can include an ATM, a DIV, applicable system servers and a robotic arm. The ATM senses a DIV equipped with a software application that facilities ATM-mirroring when the DIV and associated equipment enter a specified communication range. After the ATM identifies a properly equipped DIV, the ATM and DIV establish a network connection. The user inputs user data (e.g., personal identification numbers (PINs)) via the DIV. The network servers act to verify the identity of the user and grant the ATM permission to access the account of the user and, subsequently, instruct a robotic arm to deliver service/property (e.g., cash, gift card, etc.) inside the cabin of the vehicle.

In aspects, the subject innovation provides substantial benefits in terms of convenience and security. One advantage for users of the subject innovation is the users may interact with the ATM/machine and subsequently collect (or submit) funds without leaving their vehicles, or, in the case of automated vehicles, even operating their vehicles. Another advantage for users is that by avoiding the need to physically use their arms external to the vehicle to complete a transaction, convenience and security is enhanced.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates an example system block diagram of mirroring between an ATM (Automated Teller Machine) and a DIV (Device in Vehicle) according to the innovation.

FIG. 2 illustrates a more detailed depiction of the example system depicted in FIG. 1.

FIG. 3 illustrates an example component diagram of an ATM and a DIV during ATM mirroring in accordance with the innovation.

FIG. 4 illustrates an example display processing protocol stack representative of ATM mirroring on a DIV according to the innovation.

FIG. 5 illustrates an example component diagram of an apparatus robotic arm suited for dispensing funds as described in aspects of the innovation.

FIG. 6 illustrates an example flow diagram of ATM modeling and distribution of funds in accordance with the innovation.

FIG. 7 illustrates a computer-readable medium or computer-readable device comprising processor-executable instructions configured to embody one or more of the provisions set forth herein, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

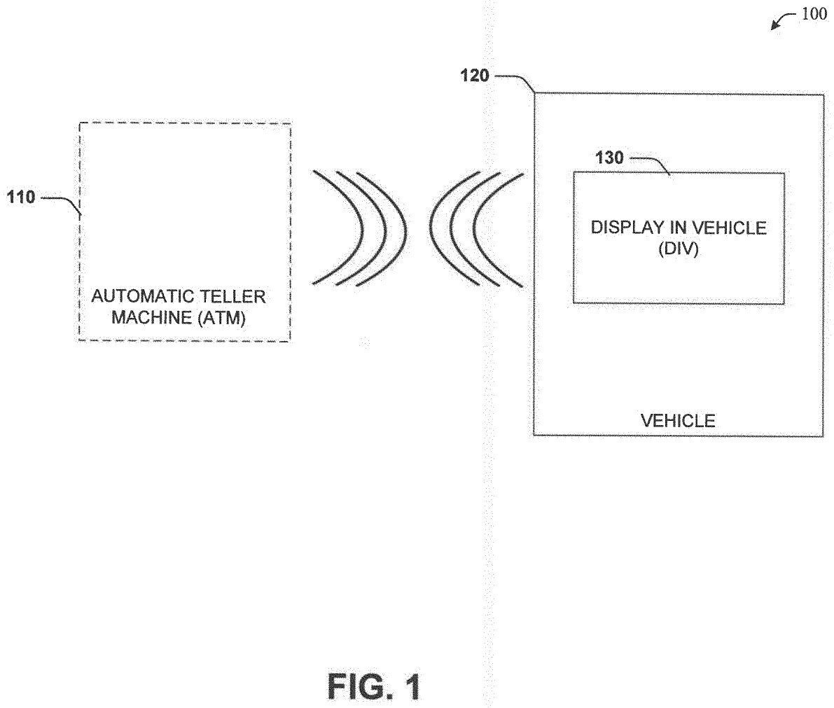

FIG. 1 illustrates a system 100 that facilitates utilization of an automatic teller machine ATM 110 via a display screen of a DIV 130 (Device in Vehicle) in accordance with aspects of the innovation. When a vehicle 120 enters within a predetermined range of an ATM 110 the ATM 110 and DIV 130 detect presence and attempt to establish a connection over a secure bank network (not shown) in order to mirror or otherwise replicate/provide the functionality of the graphic user interface (GUI) of the ATM 110 on the display of the DIV 130. In some embodiments, the ATM 110 is a server that hosts banking operations accessed by the DIV 130, thus virtually presenting the ATM 110 functionality inside the vehicle 120, e.g., with active iconic soft buttons. The DIV 130 displays each step pertaining to transaction information. As an alternative to the proximity-based connection between the ATM 110 and DIV 130 described above, the connection used for mirroring may be made through an external server. In some embodiments, the connection may be initiated by the ATM 110 or the DIV 130.

In aspects, either, or both, the ATM 110 or the DIV 130 (or device outside a vehicle (e.g., smartphone in a walkup scenario) can listen or otherwise actively monitor for an opportunity to pair or otherwise connect. As will be understood, most any communication or network protocol can be used in aspects including, but not limited to, Bluetooth, NFC (near field communication), wireless, cellular, or the like.

While aspects described herein are related to mirroring or replicating functionality and/or GUIs within a vehicle, it is to be understood that alternative aspects can include mirroring and/or replicating ATM functionality upon most any electronic device. By way of example and not limitation, functionality replication can be conveyed or transferred to most any mobile device (e.g., smartphone, tablet, smartwatch, etc.) without departing from the spirit and/or scope of the innovation and claims appended hereto. Similarly, while traditional ATM communication is effected via buttons/keypads, the innovation herein contemplates alternative inputs including, but not limited to voice commands, graffiti on touch screen, or the like. It will be appreciated that, in examples, a user will have more privacy within the cabin a vehicle thereby enhancing the ability to use alternative input modalities. These alternative aspects are to be included within the scope of the innovation and claims appended hereto.

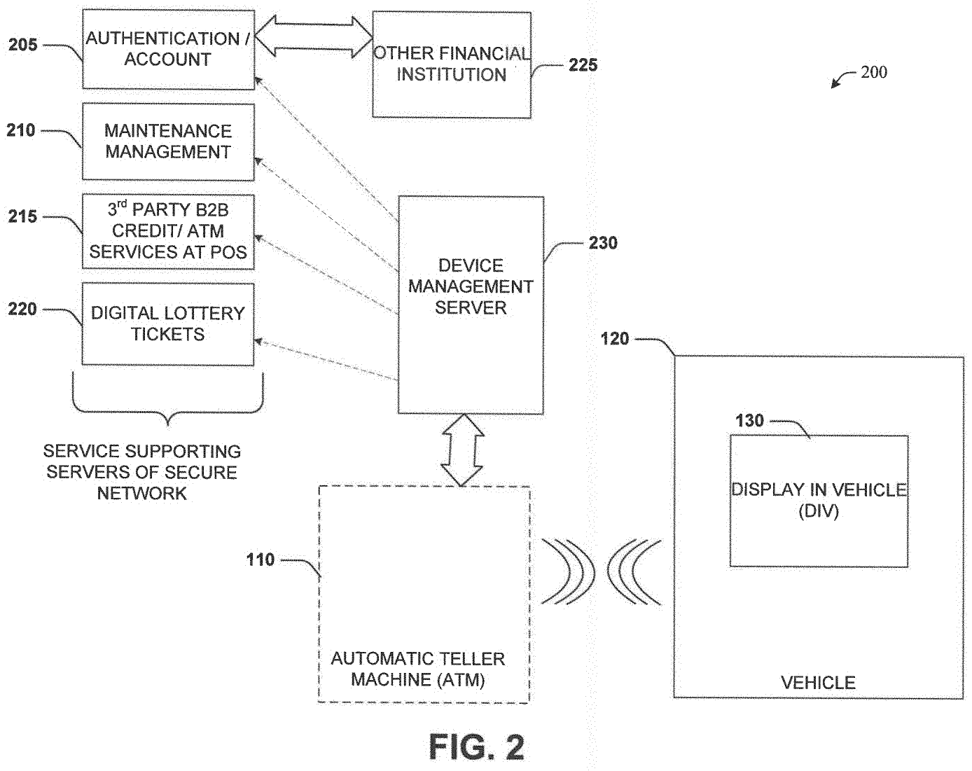

FIG. 2 is a more detailed depiction of the example system shown in FIG. 1, including additional elements employed in the mirroring operation, namely service supporting servers (SSS) (e.g., 205, 210, 215, 220) of a secure banking network, and if necessary/desired, a server associated with a third-party banking/financial institution 225 along with, a device management server (DMS) 230. Note that additional service supporting servers, not shown in FIG. 2, may be included. Such servers are contemplated in the innovation and are to be included within the scope and claims appended hereto.

To perform the mirroring operation, in an aspect, the system 200 can utilize a software application stored in the DIV 130, a smart software client installed in the ATM and service supporting servers (SSS) in a cloud or financial industry network. The DMS 230 manages the SSS for system operations, and can perform as a gateway between the ATM 110 and the SSS. In aspects, the system can also include a robotic arm (not shown in FIG. 2) operative to dispense the assets to the user. In an aspect, the mirroring operation employs a three level authentication/authorization process as follows:
Authorization for Mirroring: The DMS 230 communicatively connects the DIV 130 and the ATM 110, for example, via a common secure banking network with a public key infrastructure (PKI). The DMS 230 facilitates exchange of a secure session key between DIV 130 and ATM 110 via the connection. The DMS 230 authorizes the DIV 130 to mirror the ATM 110 based on the session key.
Authentication for Financial Transaction: The authentication/account server 205 receives the ATM card (or account) information of the user over the secure banking network. The DIV 130 provides the ATM 110 at least one additional authentication credential, such as a personal identification number (PIN), biometric data (e.g., finger/voice print), etc. The ATM 110 forwards essential account information and the additional authentication credentials to the authentication server 205. The authentication server 205 compares the account information and additional credentials to previously verified, stored user information. If the information matches the stored user information, the authentication server 205 sends an approval code to the ATM 110 through the DMS 230.
Authentication for Use of Robotic Arm to Dispense Funds: The DIV 130 provides the ATM 110 at least one additional credential. The ATM 110 forwards the additional credentials to the authentication server 205. The authentication server 205 compares the additional credential to previously verified, stored user information. If the information matches the stored user information, the authentication server 205 sends a first approval code to the ATM 110 through the DMS 230. The authentication server 205 server sends a second approval code to the robotic arm controller (not shown). Upon receipt of the second approval code, the robotic arm dispenses the assets to the user, preferably within the cabin of the vehicle operated by the user.

While the mirroring operation has been described above with reference to a secure banking network, other available networks, such as a mobile network associated with the DIV 130 may also be used without departing from the spirt and/or scope of the innovation and claims appended hereto. While the described illustrations depict a proximity connection between the ATM 110 and DIV 130, it is to be appreciated that data exchange may also take place through a remote (e.g., cloud-based) server. In alternate embodiments, through caching, machine learning, password retention, etc., multiple authentication steps can be simplified and future mirroring can be facilitated with less user input. These and other contemplated aspects are to be included within the spirit and scope of the innovation and claims appended hereto.

The ATM 110 and DIV 130 may implement a packet manager which securely handles the information exchange between the ATM 110 and DIV 130. As will be appreciated, the transmission of sensitive information can be processed in accordance with known protocols.

Regarding Authentication for Financial Transaction
In some embodiments, the ATM card (or account) information can be securely saved in the DIV in a hashed/encrypted form. In these embodiments, the card can be referred to as a Virtual ATM Card, or V-ATM Card. As will be understood, a V-ATM card enhances convenience and reduces the risk of theft (or misplacement) of a physical ATM card. Alternatively, the DIV may be retrofit to accept a virtual card, for instance, with an off-the-shelf card reader or chip reader. The card reader will allow the user to swipe his or her ATM card.
In another embodiment, the DIV may send ATM card (or account) information to the authentication server 205 on a secure channel, not established through the ATM network, but provided by the mobile network of a mobile network service provider.
In yet another embodiment, a combination of both channels (ATM network and mobile network) could be used to augment authenticity and security.
For enhanced security, it is appreciated that complete recognition of the user and card (virtual or physical), may request the user to input further credentials including, but not limited to, a Personal Identification Number (PIN), biometric data and/or the like.
In an embodiment, a digital wallet of the user can be employed for the financial transaction. For instance, the digital wallet will reside either on the mobile device of the user or on the DIV.

Upon delivery of services/property in the cabin of the vehicle, the secure channel between the ATM 110 and the DIV 130 is decoupled and, in some aspects, all session data is destroyed.

In yet other aspects, the innovation allows for seamless roaming. Roaming in this context refers to when a user utilizes a third-party ATM, locally or in a foreign country. In such an instance, the DMS of the third-party institution passes the ID identification to the DMS 230 of the user for verification. Upon verification, the third-party ATM allows mirroring.

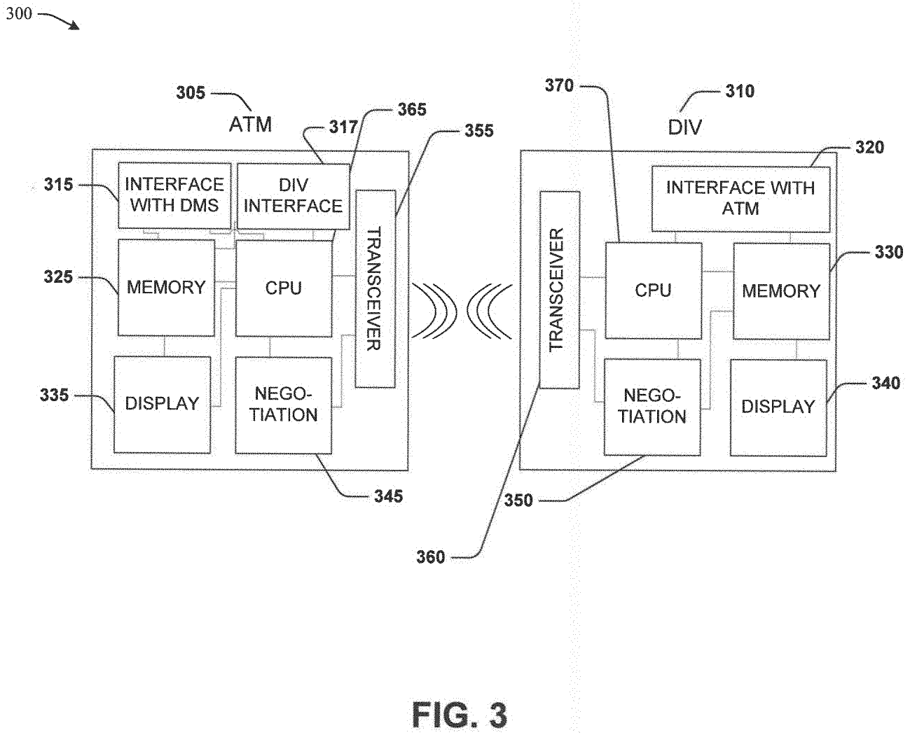

FIG. 3 illustrates an example component diagram 300 of an ATM 305 and a DIV 310 during ATM 305 mirroring in accordance with aspects of the innovation. In operation, the ATM 305 and DIV 310 share a secure wireless connection. The ATM 305 can serve as a host and the DIV 310 can serve as a client for operations for carrying out a financial transaction. Descriptions for the various components, in accordance with example embodiments, follow.
Interface (315, 320): A graphical user interface (GUI) is a mechanism by which a user may communicate with an electronic device via direct manipulation of graphical icons and resulting visual indications. This mechanism is much more intuitive than with command-line interfaces that characterized early computer interfaces. In some embodiments, the GUI may include a keyboard, mouse, touch screen, and/or the like. Further, the GUI or Interface (315, 320) may interact with a microphone or other sensors, e.g., to effect voice or haptic input/communication.
Memory (325, 330): Memory constitutes a class of hardware components operative to store information for future use in binary form.
Display (335, 340): In some embodiments, a display may be a liquid crystal display (LCD), TFT, LED, and/or the like for rendering images for display. In one embodiment, an LCD is a two-dimensional display that utilizes liquid crystals (hybrid substances having both liquid and crystalline solid properties) backlit, to generate a desired image.
Device Capability Negotiation (345, 350): A client and server (e.g. the DIV 310 and ATM 305) agree upon common communication standards and security features before deeming the connection sufficiently secure. After a server and client are connected (e.g., over a network) a client may send a negotiation request to the server, the negotiation request includes packets that inform the server of the dialects of a given communication protocol that the server supports. If the server supports the dialects identified in the negotiation message, the client and server can authenticate the connection as secure. If the server is not configured to support a dialect specified in the negotiation message, the server may utilize an earlier version of the dialect. In this case the client may not share certain information with the server for fear that, due to the outdated dialect utilized by the server, the information may be compromised.
Transceiver (355, 360): A transceiver is a device that may both transmit and receive signals.
CPU (365, 370): A central processing unit is comprised of hardware operative to perform the logical, control, and other operations necessary to carryout instructions a computer or similar electronic device receives.

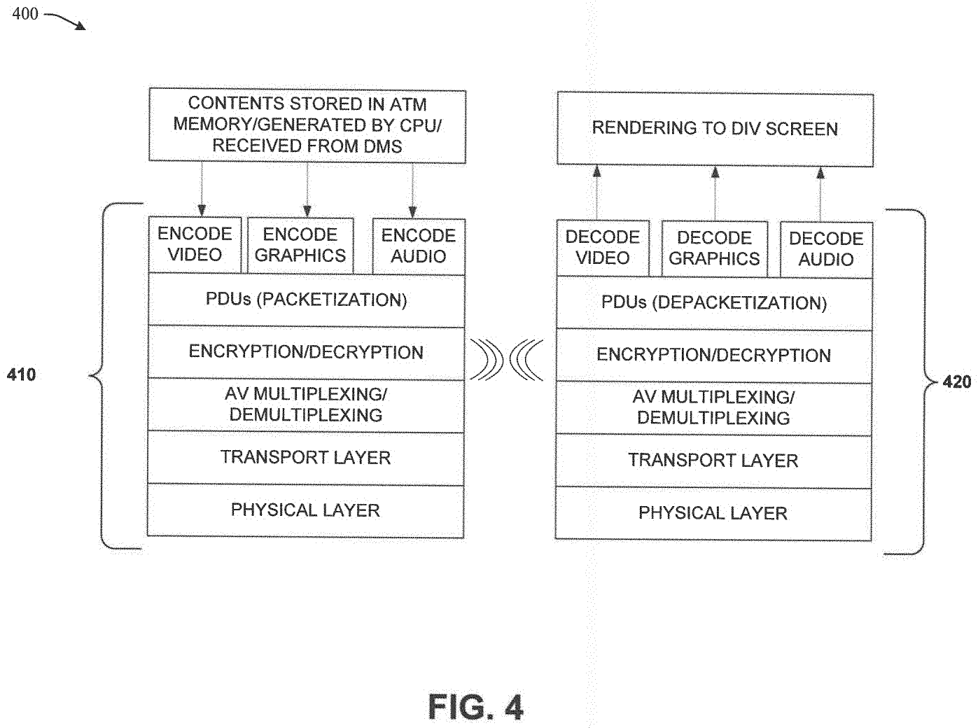

FIG. 4 illustrates an example display processing protocol stack (410, 420) reflecting the process shown in FIG. 3. A general description of the 7 layers of the OSI (Open Systems Interconnection) model is given below. Specific communication protocols or operations are listed where appropriate.
Physical Layer: The physical layer details the electrical and physical specifications of the data connection. The physical layer describes the relationship between an electronic device and a transmission medium. In some embodiments, the physical layer employs Near Filed Communication (NFC), Bluetooth, RFID (Radio-frequency identification), and ZigBee or like protocols for physical layer operations.
Data Link Layer: The data link layer details a protocol to form and/or terminate a connection between physically connected devices
Network Layer: The network layer facilitates transferring variable length data sequences from one node to another in a network. Network layer functions include routing and traffic control.
Transport Layer: The transport layer facilitates transferring variable-length data sequences from a source to a host via one or more networks. Transport layer functions include segmentation, acknowledgement, and multiplexing.
Session Layer: The session layer facilitates connections between computers including managing connections between local and remote applications.
Presentation Layer: The presentation layer places data in a form that will be accepted by the application. Presentation layer functions include character encoding and data compression. In aspects of the innovation, video encoding and decoding, graphics encoding and decoding, and audio encoding and decoding are accomplished at the presentation layer. In some embodiments, video encoding and decoding, graphics encoding and decoding, and audio encoding and decoding are accomplished on the presentation layer.
Application Layer: The application layer interacts directly with both the OSI application layer and the user. The application layer functions include determining whether sufficient network resources for requested network communication. In aspects of the innovation, the Application Layer is responsible for rendering the GUI of the ATM on the DIV screen.

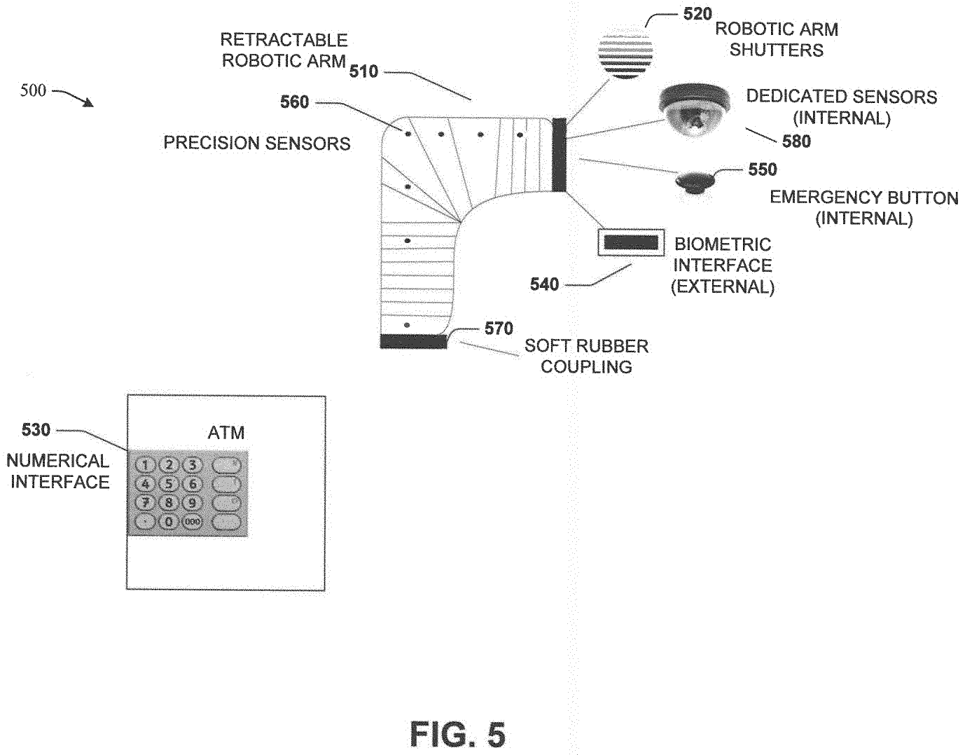

FIG. 5 illustrates an example retractable robotic arm 510 capable of distributing (or collecting) services/property (e.g., cash or gift cards) inside the vehicle cabin of an ATM patron. The retractable robotic arm 510 is operative to dispense funds to an ATM patron, directly into the cabin of a motor vehicle. The retractable robotic arm 510 resides in a housing with adaptable shutters 520. The adaptable shutters 520 open to allow the retractable robotic arm 510 to extend for the purpose of dispersing funds into the cabin of a motor vehicle of an ATM patron. Otherwise, the adaptable shutters 520 remain closed. The retractable robotic arm 510 is associated with a means that gather credentials used to verify user identify before disbursement of funds via the retractable robotic arm 510 is authorized. The means for gathering credentials may include a first interface 530 for receipt of numerical information such as a PIN associated with the ATM patron and a second interface 540 for collection of at least one biometric identifier. The first interface 530 may be a DIV operative to mirror the GUI of the ATM.

The retractable robotic arm 510 can be fitted with an emergency button 550, exposed while the arm is deployed, that, when actuated by the ATM patron, will notify authorities via a silent alarm. In other aspects, voice or other audible commands can be employed.

Additionally, the retractable robotic arm 510 is fitted with precision sensors 560 that sense the proximity of the arm 510 to the vehicle of the patron, as well as other objects or persons, so as to avoid accidental collisions. The precision sensors 560 also guide the retractable robotic arm 510 to a vehicle window.

The retractable robotic arm 510 can be coupled to the ATM via a soft rubber coupling 570. In aspects, the retractable robotic arm 510 is programmed to knock at the vehicle window in the event the window is closed.

Dedicated sensors 580 reside within the housing. The dedicated sensors 580 scan the retractable robotic arm 510 for skimmers, infections and other malicious programs when it retracts after dispensing funds. The dedicated sensors 580 mitigate most any threats found during scanning.

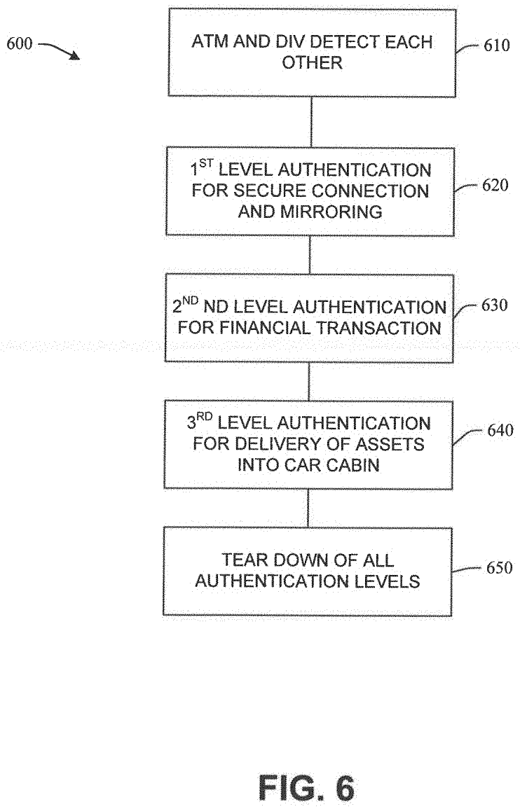

With reference to FIG. 6, example method 600 is depicted for authenticating a user to verify identity. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 600 is described in conjunction with a specific example is for explanation purposes.

FIG. 6 illustrates an example flow diagram of ATM mirroring and distribution of funds. At 610, an ATM detects an electronic device having a software application that will facilitate mirroring of an ATM is within a predetermined operational range of the ATM. In some embodiments, the electronic device can detect the presence of the ATM.

At 620, the ATM and electronic device establish a secure connection (e.g., a proximate connection or a connection made via a server). After the secure connection is established, the electronic device receives authorization to mirror the GUI of the ATM.

At 630, an identity of the user is established. The identity is established by collecting at least one credential (e.g. ATM or Virtual ATM information and/or a PIN). The credentials are compared to information stored on the secure financial network associated with the ATM. In some embodiments, the user provides at least two credentials. If the identity of the user is verified (e.g., via PIN, biometrics, etc.), the user receives authorization to access the financial account of the user for financial transactions.

At 640, the ATM collects at least one additional credential. The at least one additional credential is compared to information stored on the secure financial network associated with the ATM. If the additional credential is verified, disbursement of service/property (e.g., cash, gift card, etc.) from the ATM is authorized.

At 650, a dispensing means (e.g., a pneumatic tube, a robotic arm, a standard ATM cash-disbursement aperture, etc.) delivers service/property to the user.

At 660, the ATM and electronic device are unpaired and the financial transaction is concluded.

It is appreciated that mirroring features, functionalities and benefits can be employed and realized in aspects of other businesses/industries, including but not limited to, Fueling Stations, Drive-Through Pharmacies, Fast Food Restaurants, among others. Adapting mirroring techniques substantially similar to the functionality described above for such Business to Business (B2B) transactions is contemplated by the innovation.

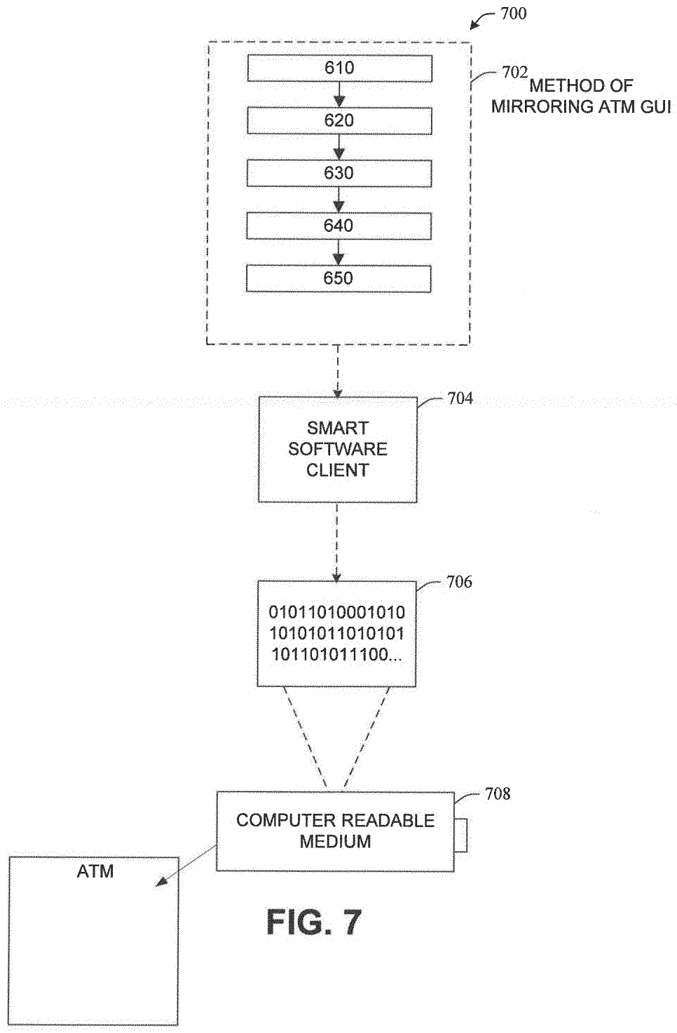

Embodiments can involve a computer-readable medium comprising processor-executable instructions configured to implement one or more embodiments of the techniques presented herein. An embodiment of a computer-readable medium or a computer-readable device that is devised in these ways is illustrated in FIG. 7, wherein an implementation 700 comprises a computer-readable medium 708, such as a CD-R, DVD-R, flash drive, a platter of a hard disk drive, etc., on which is encoded computer-readable data 706. This computer-readable data 706, such as binary data comprising a plurality of zero's and one's as shown in 706, in turn comprises a set of computer instructions 704 configured to operate according to one or more of the principles set forth herein. In one such embodiment 700, the processor-executable computer instructions 704 are configured to perform a method 702, such as at least a portion of one or more of the methods described in connection with embodiments disclosed herein. In another embodiment, the processor-executable instructions 704 are configured to implement a system, such as at least a portion of one or more of the systems described in connection with embodiments disclosed herein. Many such computer-readable media can be devised by those of ordinary skill in the art that are configured to operate in accordance with the techniques presented herein.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method for utilizing an automated teller machine (ATM), comprising:
detecting a computing device comprising a display in a vehicle within a predetermined range of an ATM;
mirroring a user interface of the ATM on a display of the computing device, wherein mirroring employs a protocol to facilitate a secure financial transaction from the vehicle as follows:
authenticating the ATM and computing device based on corresponding credentials;
establishing a secure connection between the ATM and the computing device by way of a device management server (DMS); and
authorizing mirroring of the user interface over the secure connection;
authenticating a user by way of a first user credential;
authorizing an account operation by the user;
receiving input via the user interface of the computing device requesting a disbursement of assets as per the account operation;
reauthenticating the user by way of the a second user credential; and
dispensing the assets from the ATM.

2. The method of claim 1, further comprising:
connecting the computing device and ATM on a common network with a public key infrastructure (PKI);
exchanging a session key between the computing device and ATM via the connection; and
authorizing the computing device to mirror the ATM based on the session key.

3. The method of claim 2, further comprising:
receiving ATM card information of the user, wherein the ATM card information is the first user credential;
sending the ATM card information of the user to an authentication server via a secure network;
collecting the second user credential; and
comparing the ATM card information and the second user credential to previously verified user information.

4. The method of claim 3, further comprising:
collecting at least a third user credential from the user;
authorizing disbursement of funds from the ATM, as per user instructions made over the computing device; and
comparing the third user credential to previously verified user information,
wherein the computing device accepts commands from the user via voice command or graffiti on touchscreen.

5. The method of claim 1, wherein the assets are dispensed directly into a cabin of the vehicle via a robotic arm, the arm being operative to alert authorities via a silent alarm upon actuation by the user.

6. The method of claim 1, further comprising:
terminating the connection between the computing device and ATM after funds are disbursed; and
destroying session data.

7. The method of claim 1, wherein the method employs a software application stored in the computing device, a smart software client installed in the ATM, or service supporting servers in a cloud or financial industry network, wherein, caching, machine learning, and password retention are provided.

8. A system for delivering automated teller machine (ATM) service into a motor vehicle, the system comprising:
an ATM operative to:
detect a computing device within a motor vehicle within a predetermined range of the ATM, wherein the computing device comprises a display on to which a user interface of the ATM can be mirrored and interacted with to request disbursement of assets,
establish a communication protocol with the computing device before regarding a connection secure such that after a connection is established between the ATM and the computing device, the ATM receives a negotiation request from the computing device, the negotiation request including a data packet that informs the ATM of a communication protocol supported by the computing device,
deem the connection as secure when the ATM and the computing device support the communication protocol identified in a negotiation message,
utilize an earlier version of the communication protocol when the ATM is not configured to support the communication protocol specified in the negotiation message and limit information from the computing device, and
receive account information from a secure store in the computing device;
a device management server (DMS) that authenticates the computing device and a user of the computing device to provide access to the ATM; and
a robotic arm operative to dispense the assets to the user.

9. The system of claim 8, wherein the system further comprises:
a software application stored in the computing device, executed by at least one processor contained therein,
a smart software client installed in the ATM, executed by at least one processor contained therein, and
at least one service supporting server (SSS), including at least an authentication server.

10. The system of claim 9, wherein the DMS manages SSS necessary for system operations, and acts as a gateway between the ATM and SSS.

11. The system of claim 10, wherein the DMS:
connects the computing device and ATM on a common network with a public key infrastructure (PKI);
facilitates exchange of a session key between the computing device and ATM via the connection; and
authorizes the computing device to mirror the ATM based on the session key.

12. The system of claim 11, wherein:
the authentication server receives ATM card information of the user over a secure network, wherein the ATM card information is a first authentication credential;
the computing device provides the ATM at least a second authentication credential;
the ATM forwards account information and the second authentication credential to the authentication server; and
the authentication server compares the account information and the first authentication credential and the second authentication credential to previously verified user information, and if the information matches, the authentication server sends an approval code to the ATM through the DMS.

13. The system of claim 12, wherein:
the computing device provides the ATM at least a third authentication credential;
the ATM forwards the third authentication credential to the authentication server;
the authentication server compares the third authentication credential to previously verified user information, and if the information matches, the authentication server sends a first approval code to the ATM through the DMS;
the authentication server sends a second approval code to the robotic arm; and
the robotic arm, upon receipt of the second approval code, dispenses assets to user.

14-20. (canceled)

21. A method, comprising:
executing, on a processor, instructions that cause the processor to perform operations comprising:
detecting presence of a computing device within a predetermined range of an automated teller machine, wherein the computing device comprises a display and forms part of or is present inside a vehicle;
authenticating the automated teller machine and the computing device based on provider credentials;
establishing a secure communication channel between the automated teller machine and the computing device after successfully authenticating the automated teller machine and the computing device;
authorizing mirroring of a user interface of the automated teller machine on the display of the computing device by way of the secure communication channel;
authenticating a user of the computing device by way of a first user credential;
authorizing an account operation by a user of the user computing device by way of the user interface mirrored on the display of the computing device after successful user authentication, wherein the account operation corresponds to asset disbursement;
reauthenticating the user by way of a second user credential; and
triggering disbursement of an asset to the user after successful reauthentication.

22. The method of claim 21, wherein triggering disbursement causes a robotic arm to extend into a cabin of the vehicle through an open window.

23. The method of claim 22, wherein the operations further comprise reauthenticating the user based on the second user credential provided through the robotic arm.

24. The method of claim 23, wherein the second user credential is a personal identification number entered on a keypad connected to the robotic arm.

25. The method of claim 21, wherein the operations further comprise terminating the secure communication channel after the asset is dispersed.

26. The method of claim 21, wherein the operations further comprise establishing the secure communication channel between the automated teller machine and the computing device by way of a server.

27. The method of claim 26, wherein the operations further comprise authorizing mirroring the user interface of a third-party automated teller machine to the display of the computing device based on communication between the server and a third-party server.
